(19) United States
(12) Patent Application Publication
(10) Pub. No.: US 2018/0011320 A1
(43) Pub. Date: Jan. 11, 2018

(54) DETACHABLE HEAD-UP DISPLAY DEVICE WITH REFLECTION SHEET

(71) Applicant: E-LEAD ELECTRONIC CO., LTD., CHANGHUA (TW)

(72) Inventor: Stephen CHEN, CHANGHUA (TW)

(21) Appl. No.: 15/205,604

(22) Filed: Jul. 8, 2016

(51) Int. Cl. G02B 27/01; B60R 11/02

(52) U.S. Cl. CPC G02B 27/0149; B60R 11/0229; G02B 2027/0169; G02B 2027/0159

(57) ABSTRACT

The present invention relates to a head-up display device with reflection sheet, the only component left on the windshield after being detached is a simple transparent sheet by using the detachable structure, so as to reduce line-of-sight obstruction for drivers to get a better field and quality of view, to thereby improve driving safety.

### BACKGROUND OF THE INVENTION

### a) Field of the Invention

The present invention relates to a detachable head-up display device with reflection sheet and, more particularly, to a detachable head-up display device with reflection sheet that could be detached for reducing line-of-sight obstruction, the only component left on the windshield after being detached is a simple transparent sheet by using the detachable structure, so as to reduce line-of-sight obstruction for drivers to get a better field and quality of view, to thereby improve driving safety.

### b) Description of Prior Art

The reason that head-up display devices are widely used in vehicles is mainly to improve driving safety, thus many manufacturers equip head-up display devices in some vehicles. By using head-up display devices, the condition that drivers distract attention on the road could be reduced. Applied technology related to head-up display devices may be referred to cited references TW patent number M516293, M497113, M510866, I509287, M514078, M515111, I518369, M462692, and TW public number 201534499, 201432311, 201537220.

From related technical content of the above cited references and experience of practical applications, some drawbacks could be found in the implementation of common head-up display devices, and the most criticized problem is that the reflection sheet may shake. For drivers, watching display device and driving quality may be directly affected by the reflection sheet shaking problem. The reason caused the reflection sheet shakes is that the dashboard receives shakes from the rotating vehicle engine or air conditioner.

In order to solve the reflection sheet shaking problem, the inventor of the present invention has already applied the patent invention with Taiwan patent number M517695, the reflection sheet shaking problem may be solved by the anti-shock technology of this cited reference. From the practical application and implementation of this cited reference, the reflection sheet shaking problem has already solved, and the effect of reducing shakes is great. Since the reflection sheet of the head-up display device should be stable and shockproof, and its occupied area obstructing line of sight on the windshield should be reduced as much as possible, most of the reflection sheets are fixed by adhering. But in this way, it is difficult to disassemble after adhering, it is also difficult to disassemble when not in use or cleaning, and it cannot be adhered again if the adhesive tape is not changed. Drivers may be troubled by these problems. However, there is still no preferred technical solution for solving these problems.

### SUMMARY OF THE INVENTION

In view of the drawbacks of the conventional ones, the inventor finally completed the detachable head-up display device with reflection sheet of the present invention after numerous improvements, for this reason:

The first object of the present invention is to provide a detachable head-up display device with reflection sheet that could be detached for reducing line-of-sight obstruction, the only component left on the windshield after being detached is a simple transparent sheet by using the detachable structure, so as to reduce line-of-sight obstruction for drivers to get a better field and quality of view, to thereby improve driving safety.

The second object of the present invention is to provide a detachable head-up display device with reflection sheet that could be detached for reducing line-of-sight obstruction, the only component left on the windshield after being detached is a simple transparent sheet by using the detachable structure, so as to reduce line-of-sight obstruction for drivers to get a better field and quality of view, to thereby improve driving safety.

To achieve the object, the detachable head-up display device with reflection sheet according to the present invention, which includes:

a reflection sheet, an engaging portion is set on its one side;

a base plate, its bottom is engaged with the engaging portion, a first chute is set on a top of the base plate;

a first fixing piece, which is provided to inset into the first chute.

The first fixing piece is made of translucent material, an adhesive set on a top side of the first fixing piece is provided to adhere the first fixing piece to a windshield.

The detachable head-up display device of the present invention, further includes an angle adjustment module, the angle adjustment module includes a first joint, a shaft structure and a second universal steering joint; the first universal steering joint is set on a front end of the bottom of the base plate and a side of the engaging portion; the second universal steering joint is set on a rear end of the bottom of the base plate; the shaft structure is set on the second universal steering joint and another side of the engaging portion.

The base plate further includes a C ring, the C ring is engaged with the first universal steering joint.

The detachable head-up display device of the second embodiment of the present invention, which includes:

a detachable reflection sheet device, including a reflection sheet, a base plate and a fixing piece; an engaging portion is set on a side of the reflection sheet; a bottom of the base plate is engaged with the engaging portion, a first chute is set on a top of the base plate; the first fixing piece is provided to inset into the first chute;

a display module, which includes a display unit, a base, a circuit board and a second fixing piece; the display unit is electrically connected to the circuit board for receiving and projecting the images output from the circuit board; a second chute is set on a top of the base; the second fixing piece is provided to insert into the second chute.

The first fixing piece and the second fixing piece are made of translucent material, two adhesives respectively set on a top side of the first fixing piece and the second fixing piece are provided to adhere the first fixing piece and the second fixing piece to a windshield.

The display module further includes a shaft set.

The detachable head-up display device of the present invention, further includes an angle adjustment module, the angle adjustment module includes a first joint, a shaft structure and a second universal steering joint; the first universal steering joint is set on a front end of the bottom of the base plate and a side of the engaging portion; the second universal steering joint is set on a rear end of the bottom of the base plate; the shaft structure is set on the second universal steering joint and another side of the engaging portion.

The circuit board further includes a operating unit, a wireless module, a speaker unit and a receiving unit.

The base plate further includes a C ring, the C ring is engaged with the first universal steering joint.

### BRIEF DESCRIPTION OF THE DRAWINGS

FIG. 1 is a three-dimensional schematic diagram of appearance of the first embodiment of the present invention;

FIG. 2 is a three-dimensional exploded diagram of the first embodiment of the present invention;

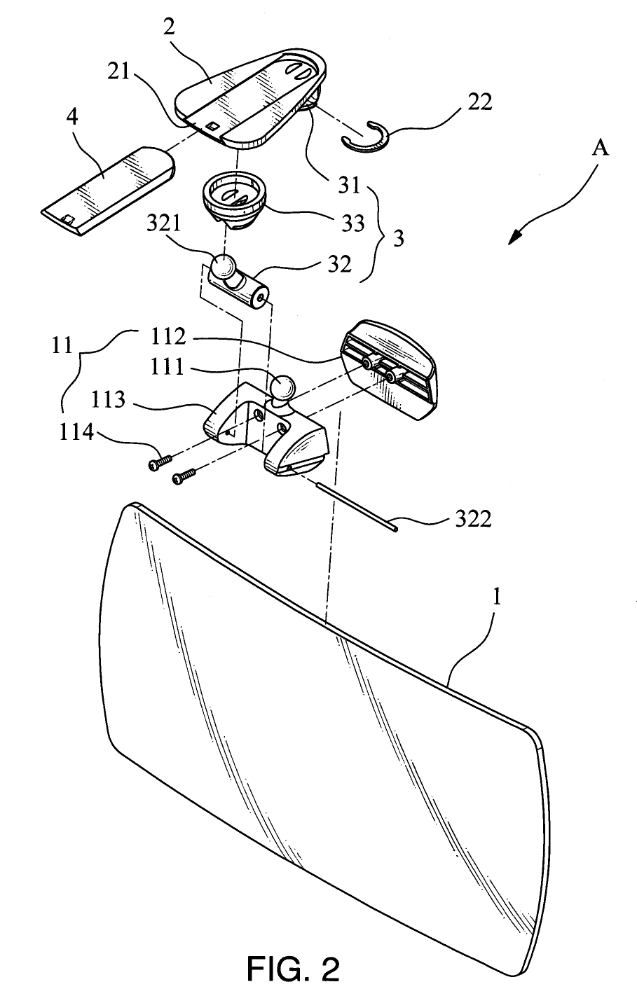

FIG. 3 is a schematic diagram of combination of the first embodiment of the present invention;

FIG. 4 is a three-dimensional schematic diagram of appearance of the second embodiment of the present invention;

FIG. 5 is a schematic diagram of combination of the second embodiment of the present invention;

FIG. 6 is a block diagram of the second embodiment of the present invention; and

FIG. 7 is a schematic diagram of embodiments of the present invention.

### DETAILED DESCRIPTION OF THE INVENTION

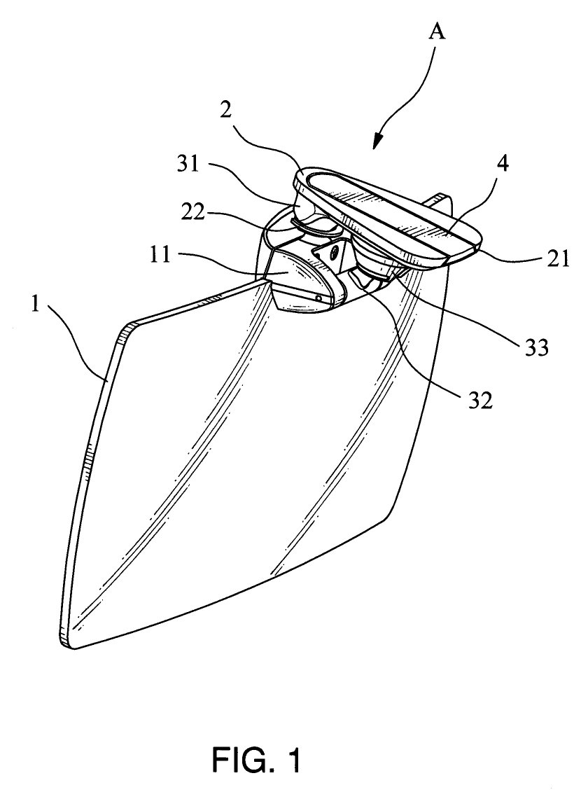

Please refer to FIG. 1, 2, 3, which is the first embodiment of the present invention, wherein the detachable reflection sheet device A includes:

a reflection sheet 1, an engaging portion 11 is set on its one side, the engaging portion 11 includes a front part 112, a rear part 113 and multiple screws 114, the reflection sheet 1 is hold by the front part 112 and the rear part 113, the screws 114 is provided to fasten the front part 112 and the rear part 113, the reflection sheet 1 is a concave mirror with transparent reflection effect;

a base plate 2, its bottom is engaged with the engaging portion 11, a first chute 21 is set on a top of the base plate 2, the engaging portion 11 is connected to a side of the base plate 2;

a first fixing piece 4, which is provided to inset into the first chute 21, the first fixing piece 4 is made of translucent material, to thereby reduce line-of-sight obstruction after the detachable reflection sheet device A is detached, an adhesives respectively set on a top side of the first fixing piece 4 are provided to adhere the first fixing piece 4 to a windshield W.

The detachable head-up display device A of the present invention, further includes an angle adjustment module 3, the angle adjustment module 3 includes a first joint 31, a shaft structure 32 and a second universal steering joint 33; the first universal steering joint 31 is set on a front end of a bottom of the base plate 2 and engaged with a first ball head 111 set on a side of the engaging portion 11; the second universal steering joint 33 is set on a rear end of the bottom of the base plate 2; the shaft structure 32 is set on another side of the engaging portion 11, a shaft 322 is inserted into the engaging portion 11 and associated with the shaft structure 32, a second ball head 321 of the shaft structure 32 is engaged with the second universal steering joint 33; the reflection sheet 1 could easily be adjusted up and down, left and right within a limited range, to get a best visual angle for drivers. The base plate 2 further includes a C ring 22, the C ring 22 is engaged with the first universal steering joint 31 for enhancing tightness of the first universal steering joint 31, to reduce the shaking of the reflection sheet 1.

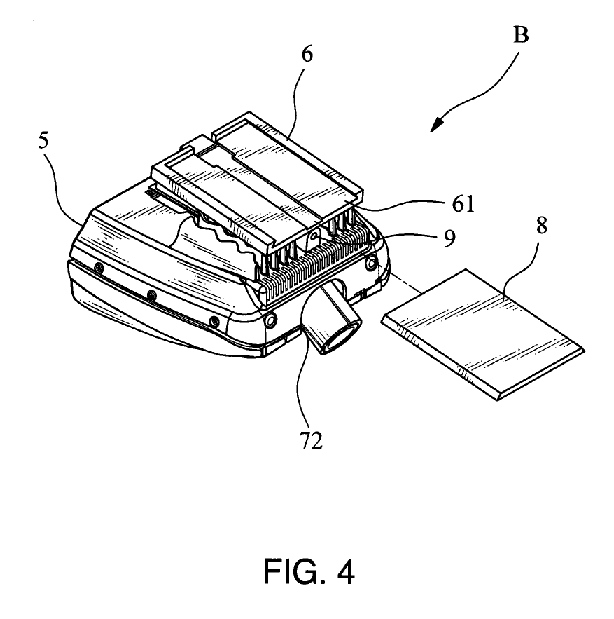

Please refer to FIG. 4, 5, 6, which is the second embodiment of the present invention, the detachable head-up display device includes a detachable reflection sheet device and a display module B, wherein:

the detachable reflection sheet device A includes:

a reflection sheet 1, an engaging portion 11 is set on its one side, the engaging portion 11 includes a front part 112, a rear part 113 and multiple screws 114, the reflection sheet 1 is hold by the front part 112 and the rear part 113, the screws 114 is provided to fasten the front part 112 and the rear part 113, the reflection sheet 1 is a concave mirror with transparent reflection effect;

a base plate 2, the engaging portion 11 is engaged with its bottom, a first chute 21 is set on a top of the base plate;

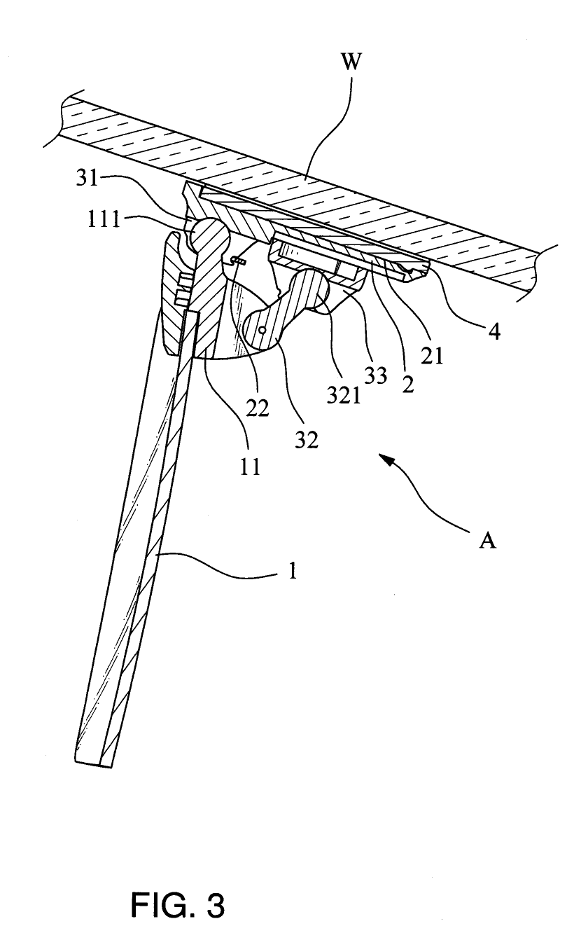

a first fixing piece 4, which is provided to inset into the first chute 21, the first fixing piece is made of translucent material, to thereby reduce line-of-sight obstruction after the detachable reflection sheet device A is detached, an adhesive set on a top side of the first fixing piece 4 is provided to adhere the first fixing piece to a windshield W (please refer to FIG. 3);

the display module B, which includes a display unit 5, a base 6, a circuit board 7 and a second fixing piece 8; the circuit board 7 includes a processor 71, the processor 71 is provided to control data and related information processing and output image information; the display unit 5 is electrically connected to the circuit board 7 for receiving and projecting the images output from the circuit board 7; a second chute 61 is set on a top of the base 6; the second fixing piece 8 is provided to insert into the second chute 61.

As shown in FIG. 3, the detachable reflection sheet device A further includes an angle adjustment module 3, the angle adjustment module 3 includes a first universal steering joint 31, a shaft structure 32 and a second universal steering joint 33; the first universal steering joint 31 is set on a front end of a bottom of the base plate 2 and engaged with a first ball head 111 set on a side of the engaging portion 11; the second universal steering joint 33 is set on a rear end of the bottom of the base plate 2; the shaft structure 32 is set on another side of the engaging portion 11, a shaft 322 is inserted into the engaging portion 11 and associated with the shaft structure 32, a second ball head 321 of the shaft structure 32 is engaged with the second universal steering joint 33; the reflection sheet 1 could easily be adjusted up and down, left and right within a limited range, to get a best visual angle for drivers. The base plate 2 further includes a C ring 22, the C ring 22 is engaged with the first universal steering joint 31 for enhancing tightness of the first universal steering joint 31, to reduce the shaking of the reflection sheet 1.

The display module B further includes a shaft set 9, the shaft set 9 is provided to easily adjust the display module B up and down, left and right within a limited range, to get a best visual angle for drivers.

The second fixing piece 8, an adhesive set on its top side is provided to adhere the second fixing piece 8 to a windshield W.

The first fixing piece is made of translucent material, an adhesive set on a top side of the first fixing piece is provided to adhere the first fixing piece to a windshield.

The second fixing piece 8 is made of translucent material, so as to reduce line-of-sight obstruction after the display module B is detached.

The reflection sheet 1 is a concave mirror with transparent reflection effect, the reflection sheet 1 is provided to enlarge a virtual image by using a concave mirror, let the distance of the virtual image become far at the same ratio and reflect end enlarge the images projected from the display module B.

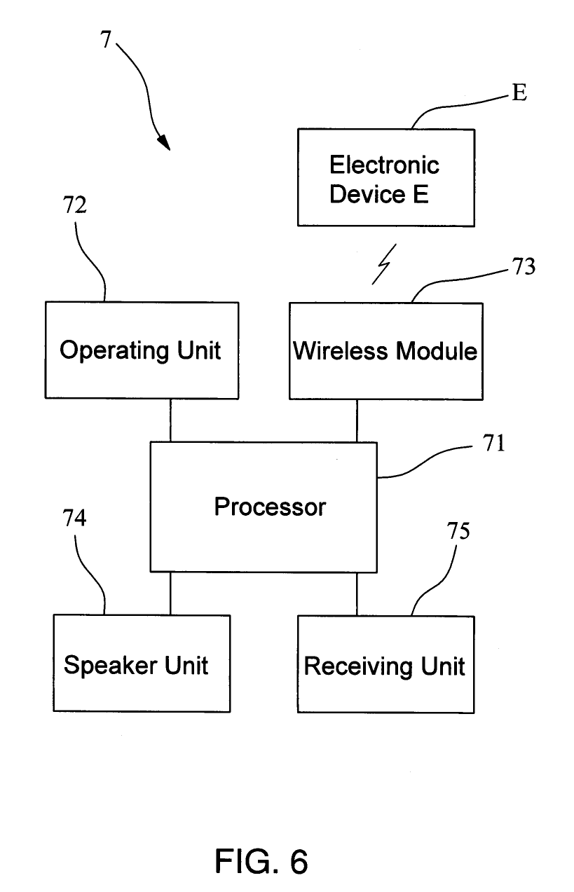

As shown in FIG. 6, the circuit board 7 further includes an operating unit 72, a wireless module 73, a speaker unit 74 and a receiving unit 75.

The operating unit 72, which is set on the display module B, is provided for operating the head-up display device.

The wireless module 73, which is provided to receive wireless signal information from a electronic device E, the wireless module 73 is Bluetooth or Wi-Fi.

The speaker unit 74 is provided to inform drivers by playing voice information, the speaker module 74 could be provided to play voice files sending from the electronic device E or use the voice files as warning sounds.

The receiving unit 75 is provided to receive voice messages as hands-free device.

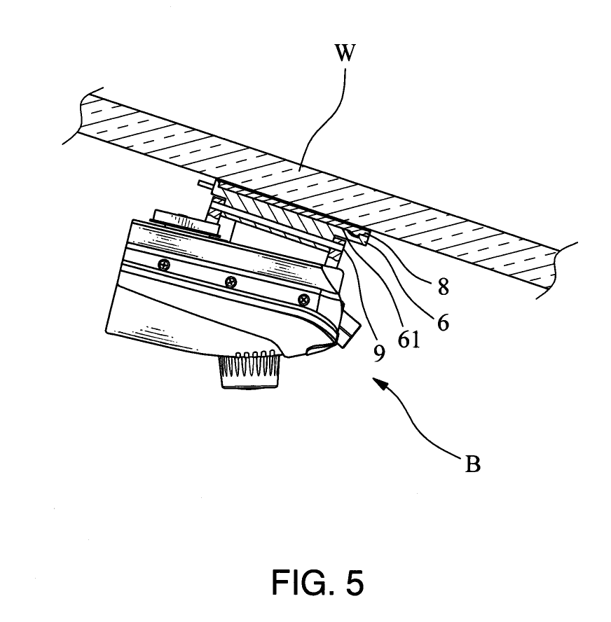

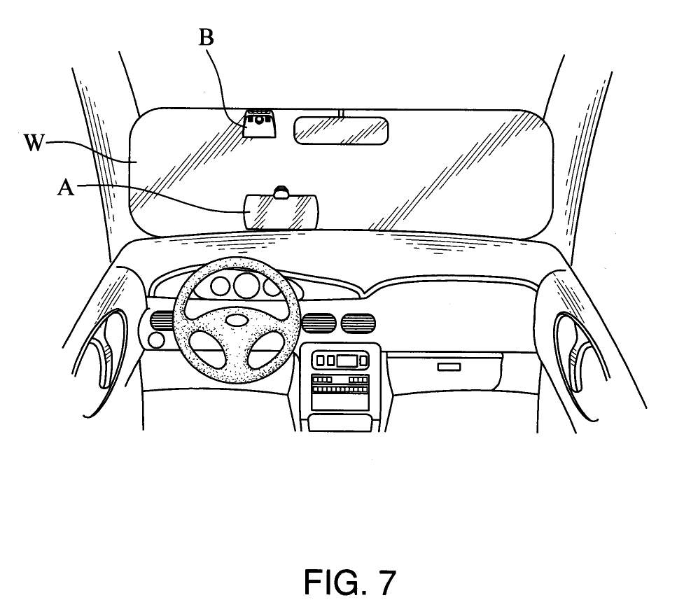

As shown in FIG. 7, which is a schematic diagram of the first and the second embodiments of the present invention. Please refer to FIG. 3 and FIG. 5 at the same time, wherein the detachable reflection sheet device A is adhered by the adhesive on the top side of the first fixing piece 4 to adhere the first fixing piece 4 to the windshield W. Similarly, the display module B is adhered by the adhesive on the top side of the second fixing piece 8 to adhere the second fixing piece 8 to the windshield W.

As above figures disclosed, the detachable reflection sheet device A and the display module B of the present invention are separate configurations, there is no connection element between them. The following advantages exist:

1. When the dashboard receives shakes from the rotating vehicle engine or air conditioner, the watching quality of the detachable reflection sheet device A may not be affected, thus the effect of reducing shakes is great.

2. No element is connected between the detachable reflection sheet device A and the display module B of the present invention, thus, there is no visual obstruction, so that drivers may have better visual field for improving driving safety.

The detachable reflection sheet device A and the display module B of the present invention is detachable structure, wherein the first fixing piece 4 and the second fixing piece 8 are made of translucent material. Thus, if the detachable reflection sheet device A and the display module B of the present invention are detached from the windshield W, even the first fixing piece 4 and the second fixing piece 8 are still left on the windshield W, because they are only simple and transparent pieces that are translucent transparent elements, they would not obstruct driver's visual field to affect driving safety.

What is claimed is:

1. A detachable reflection sheet device, which includes:
a reflection sheet, an engaging portion is set on its one side;
a base plate, its bottom is engaged with the engaging portion, a first chute is set on a top of the base plate;
a first fixing piece, which is provided to inset into the first chute.

2. The detachable reflection sheet device as claimed in claim 1, wherein the first fixing piece is made of translucent material, an adhesive set on a top side of the first fixing piece is provided to adhere the first fixing piece to a windshield.

3. The detachable reflection sheet device as claimed in claim 1, further includes an angle adjustment module, the angle adjustment module includes a first universal steering joint, a shaft structure and a second universal steering joint; the first universal steering joint is set on a front end of a bottom of the base plate and a side of the engaging portion; the second universal steering joint is set on a rear end of the bottom of the base plate; the shaft structure is set on the second universal steering joint and another side of the engaging portion.

4. The detachable reflection sheet device as claimed in claim 1, wherein the base plate further includes a C ring, a first universal steering joint, the C ring is engaged with the first universal steering joint.

5. A detachable head-up display device, which includes:
a detachable reflection sheet device, including a reflection sheet, a base plate and a fixing piece;
an engaging portion is set on a side of the reflection sheet; a bottom of the base plate is engaged with the engaging portion, a first chute is set on a top of the base plate; the first fixing piece is provided to inset into the first chute;
a display module, which includes a display unit, a base, a circuit board and a second fixing piece; the display unit is electrically connect to the circuit board for receiving and projecting the images output from the circuit board; a second chute is set on a top of the base; the second fixing piece is provided to insert into the second chute.

6. The detachable head-up display device as claimed in claim 5, wherein the first fixing piece and the second fixing piece are made of translucent material, two adhesive respectively set on a top side of the first fixing piece and a top side of the second fixing piece are provided to adhere the first fixing piece and the second fixing piece to a windshield.

7. The detachable head-up display device as claimed in claim 5, wherein the display module further includes a shaft set.

8. The detachable head-up display device as claimed in claim 5, wherein the detachable reflection sheet device further includes an angle adjustment module, the angle adjustment module includes a first universal steering joint, a shaft structure and a second universal steering joint; the first universal steering joint is set on a front end of a bottom of the base plate and a side of the engaging portion; the second universal steering joint is set on a rear end of the bottom of the base plate; the shaft structure is set on the second universal steering joint and another side of the engaging portion.

9. The detachable head-up display device as claimed in claim 5, wherein the circuit board further includes an operating unit, a wireless module, a speaker unit and a receiving unit.

10. The detachable head-up display device as claimed in claim 5, wherein the base plate further includes a C ring, a first universal steering joint, the C ring is provided to engage with the first universal steering joint.
